(19) United States
(12) Patent Application Publication
(10) Pub. No.: US 2026/0040203 A1
(43) Pub. Date: Feb. 5, 2026

(54) SUPPORT FOR STORE AND FORWARD OPERATION

(71) Applicant: InterDigital Patent Holdings, Inc., Wilmington, DE (US)

(72) Inventors: Dylan Watts, Montreal (CA); Umer Salim, Vallauris (FR); Brian Martin, Farnham (GB); Keiichi Kubota, Tokyo (JP)

(73) Assignee: InterDigital Patent Holdings, Inc., Wilmington, DE (US)

(21) Appl. No.: 18/794,823

(22) Filed: Aug. 5, 2024

(51) Int. Cl. H04W 48/20

(52) U.S. Cl. CPC H04W 48/20

(57) ABSTRACT

Systems and methods may be provided for prioritizing neighboring cell(s) during store and forward operation, e.g., in non-terrestrial networks (NTNs). One or more network entities (e.g., neighboring cell(s) or satellite(s) may be prioritized during store and forward operation based on at least remaining downlink (DL) non-access stratum (NAS) messages associated with an initiated procedure (e.g., a TAU procedure or an attach procedure) and/or network assistance information. Prioritizing a network entity may include determining whether the network entity is in store and forward mode. The WTRU as part of the prioritization may apply a cell selection bias to measurements associated with the network entity. The WTRU may send messages (e.g., RACH messages) to initiate a connection (e.g., a random access procedure) with the prioritized network entity. The WTRU (e.g., upon completion of the initiated procedure) may initiate neighbor cell measurements and/or mobility to determine the best available cell to continue connection.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein related to support for store and forward operations, e.g., in non-terrestrial networks (NTNs). An example device may include a processor configured to perform one or more actions (e.g., to accomplish a method/procedure). For example, a device (e.g., a wireless transmit/receive unit (WTRU)) may (e.g., be configured to) send a message to a first network entity. The message being sent to the first network entity may indicate initiation of a procedure (e.g., a TAU procedure or an attach procedure).

The device may obtain store and forward assistance information associated with a second network entity. The first network entity or the second network entity may be a cell or a satellite.

In an example, the device may receive the store and forward assistance information from the first network entity via one of system information, downlink control information (DCI), a medium access control-control element (MAC CE), or a random access message. In another example, the device may derive the store and forward assistance information based on at least a configuration associated with the device or other assistance information.

The device may prioritize the second network entity based on the store and forward assistance information. The store and forward assistance information may include an indication that a downlink (DL) core network (CN) message associated with an initiated procedure is available for reception from the second network entity. The device may determine that the second network entity is in store and forward mode. The device may make the determination based on an indication provided by the store and forward assistance information. As part of the prioritizing the second network entity, the device may apply at least one cell selection bias to measurements associated with the second network entity. The device may apply the at least one cell selection bias based on satisfaction of one or more criteria.

The device, while waiting for a DL NAS message (e.g., a subsequent DL NAS response message), for example, may suspend an AS functionality or initiate a random access procedure with the second network entity.

The device may perform cell reselection with a cell associated with the prioritized second network entity. The device, based at least on the store and forward assistance information, may identify the second network entity where the DL CN message may be available, and the set of resources on which the DL CN message may be available for reception. The device may receive the DL CN message associated with the initiated procedure from the prioritized second network entity using the set of resources indicated in the store and forward assistance information.

The device may receive a subsequent (e.g., a final) DL CN message in response to an uplink (UL) CN message. Based on a determination that the initiated procedure is complete, the device may perform at least one or more of the following: initiating a cell re-selection, initiating a cell measurement, sending a measurement report, or trigger mobility.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of a store and forward operation in non-terrestrial networks according to an embodiment

FIG. 3 illustrates an example of multiple exchanges between a WTRU and a CN with multiple satellite passes and extensive delay during a store and forward operation according to an embodiment

FIG. 4 illustrates an example of reception of a subsequent downlink (DL) response message from the CN during a store and forward operation according to an embodiment.

### EXAMPLE NETWORKS FOR IMPLEMENTATION OF THE EMBODIMENTS

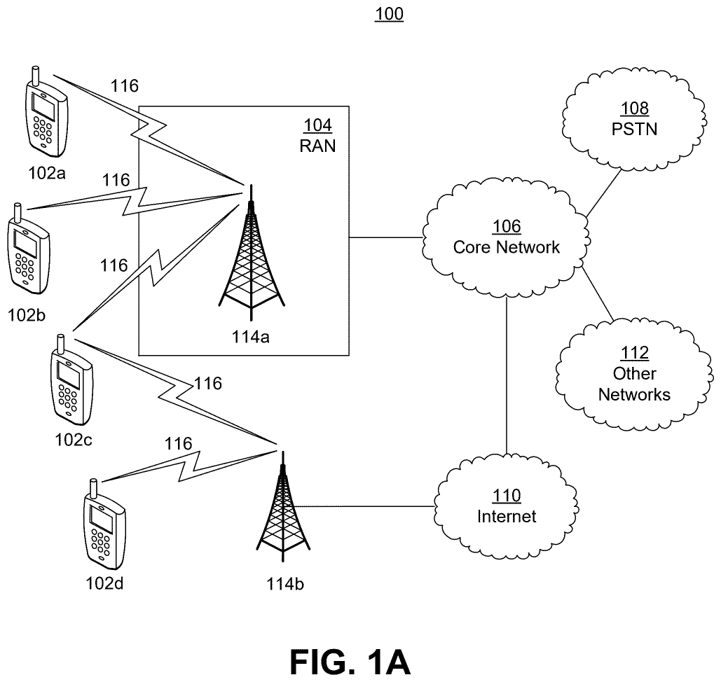

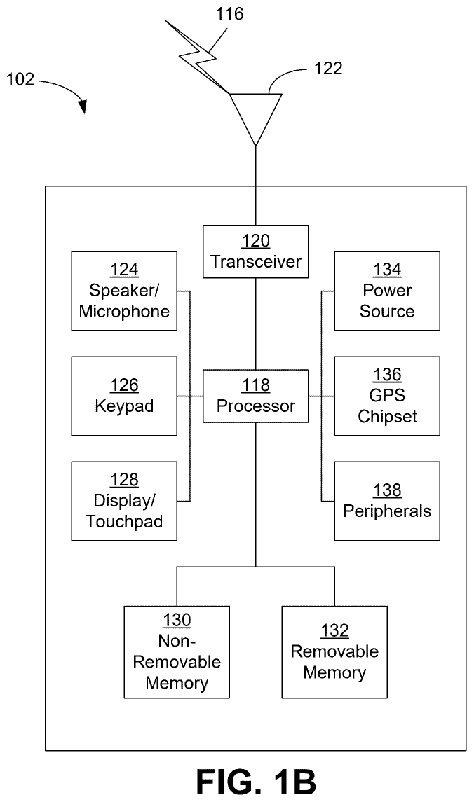

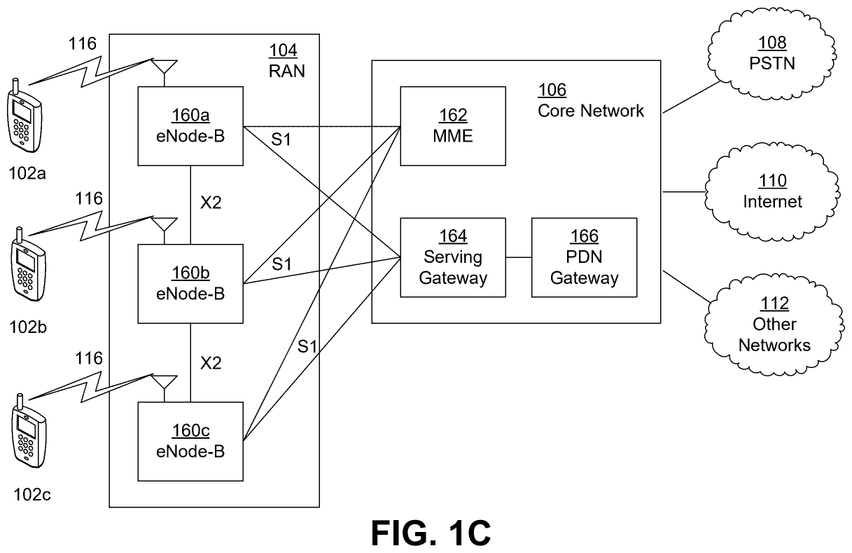

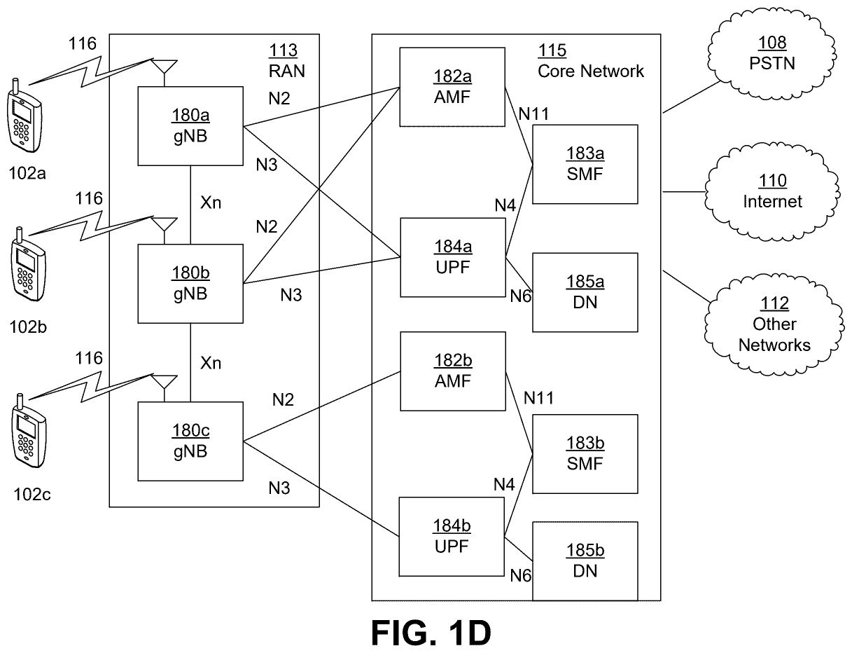

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein related to support for store and forward operations, e.g., in non-terrestrial networks (NTNs). A wireless transmit/receive unit (WTRU)) may be provided with assistance information to support store and forward (S & F) information, e.g., including for S & F operation, cell access during S & F operation, transmission/reception during S & F operation, data handling, and/or routing assistance information. The WTRU may calculate one or more aspects of store and forward information (e.g., the start, end, and/or duration), for example, via other information (e.g., NTN deployment characteristics or satellite assistance information). The WTRU may provide WTRU assistance information to support network (NW) S & F operation, e.g., including WTRU capabilities, quality of service (QoS) profiles, and/or buffered status.

A WTRU may perform cell (re)selection during S & F operation. For example, a WTRU may prioritize camping on cell(s) not currently in S & F operation (e.g., via application of a bias, modifying frequency priority, barring cells). The WTRU may apply cell prioritization methods, for example, indefinitely or subject to a time period. A WTRU camped on or about to be camped on an S & F cell (e.g., due to no other suitable alternative being available) may trigger a cell search/cell (re)selection, for example, based on additional criteria. A WTRU may modify handling (e.g., suspend, release) of stored (pre) configured mobility configurations (e.g., for CHO/LTM), for example, based on whether the candidate cell is in or about to enter S & F operation.

A WTRU may engage in messaging during S & F operation. For example, a WTRU may be rejected from accessing a cell under S & F operation (e.g., to perform an initial transmission), e.g., based on one or more of the access categories, QoS profile, and/or whether the device context is currently registered in the core network. A WTRU may prioritize (e.g., via application of a bias, modifying frequency priority, barring cells) the cell(s) originating from an upcoming satellite that may be storing the subsequent DL response message from the core network. A WTRU may suspend AS operation (e.g., neighbor cell measurements, cell (re)selection) while the WTRU is awaiting the arrival of the incoming satellite that may have stored the subsequent DL response message. A WTRU may detect (e.g., during a procedure initiated on an S & F cell) that a suitable cell is not in store and forward operation is available. The WTRU may cancel the procedure on the S & F cell and initiate and/or establish a connection with the cell not under S & F operation (e.g., with a new access cause).

A WTRU may engage in latency adaptation during S & F operation. For example, a WTRU may adapt (e.g., suspend, stop, offset, extend) one or more NAS (non-access stratum) timers during S & F operation. A WTRU may be provided with an offset to apply to one or more NAS timers, or the WTRU may calculate the offset based on, for example, one or more of the following: satellite assistance information, S & F assistance information, and/or the number of remaining messages within the initiated procedure.

A non-terrestrial network (NTN) may include an aerial or space-borne platform which, e.g., via a gateway (GW), may transport signals from a land-based based gNB to a WTRU, and vice-versa. Aerial or space-borne platforms may be classified in terms of orbit. Non-geosynchronous orbit (NGSO) satellites may include low-earth orbit (LEO) satellites, e.g., with an altitude range of 300-1500 km, and medium-earth orbit (MEO) satellites, e.g., with an altitude range of 7000-25000 km. NGSO satellites may move continuously overhead relative to Earth. Geosynchronous orbit (GSO) satellites may remain fixed overhead, e.g., by maintaining an altitude at 35,786 km.

Satellite platforms may be (e.g., further) classified as having a transparent or regenerative payload. Transparent satellite payloads may implement frequency conversion and RF amplification in uplink and downlink. Multiple transparent satellites may be connected to one land-based gNB. Regenerative satellite payloads may implement a full gNB or a gNB DU onboard the satellite. Regenerative payloads may perform digital processing on the signal, e.g., including demodulation, decoding, re-encoding, re-modulation, and/or filtering.

An NTN satellite may support multiple cells. A (e.g., each) cell may include one or more satellite beams. Satellite beams may cover a footprint on Earth (e.g., like a terrestrial cell). Satellite beams may range in diameter, for example, from 100-1000 km in NGSO deployments, and 200-3500 km diameter in GSO deployments. Beam footprints (e.g., the area covered by a beam/cell) in GSO deployments may remain fixed relative to Earth. Beam footprints in NGSO deployments may change over time, e.g., due to satellite movement. Beam movement may be classified as “earth moving,” e.g., where an NGSO beam may move continuously across the earth, or “earth fixed,” e.g., where the beam may be steered to remain covering a fixed location until a new cell overtakes the coverage area in a discrete and coordinated change.

Non-terrestrial networks may be associated with one or more of the following operational aspects: 1) continuous movement of NGSO satellites overhead, which may result in frequent and continuous cell change; 2) cell sizes up to 3500 km in diameter; or 3) round trip times (RTT) several orders of magnitude larger than terrestrial networks (e.g., up to 541.46 ms).

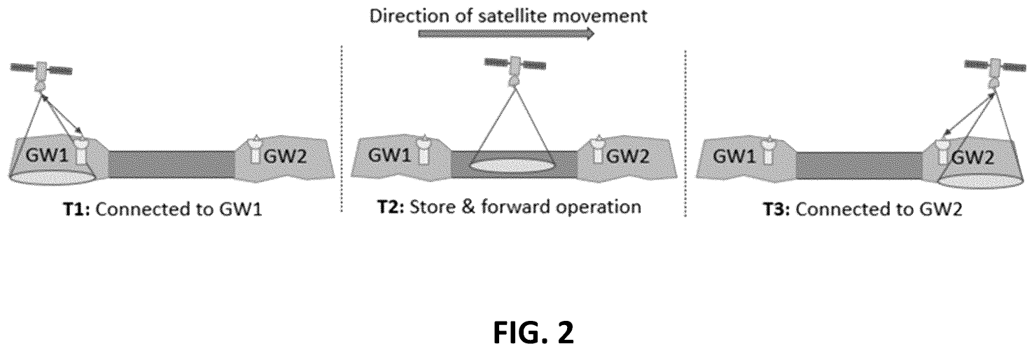

A Store and forward (S & F) operation may allow for delay-tolerant, non-real-time services to be offered in areas visited by satellites without an NTN gateway infrastructure (e.g., mid-sea). FIG. 2 illustrates an example of a store and forward operation in non-terrestrial networks according to an embodiment. While in S & F operation, information may be stored onboard a satellite and relayed to the ground upon reconnection with a gateway (e.g., GW2 shown in FIG. 2). Response messages may be sent by the network, for example, by identifying a ground-connected satellite (e.g., via GW1 shown in FIG. 2), which may (e.g., next) provide coverage to the S & F area. Response messages may (e.g., then) be stored until the satellite is within coverage of the S & F area and relayed to the WTRU.

Support for store and forward operation may be provided for in non-terrestrial networks. Support may include, for example, a split mobility management entity (split MME) architecture. A split MME may include a full MME located on the ground (e.g., MME-Terrestrial (MME-T) that may (e.g., be configured to) manage (e.g., all existing) functionality of an existing MME and an MME onboard the satellite (e.g., MME-non-terrestrial (MME-NT) that may (e.g., be configured to) perform a subset of MME functionality to assist store and forward operations (e.g., maintaining the S1 connection towards the radio access network (RAN) node and/or relaying NAS messaging between the RAN node and the MME-T).

During S & F operation, exchanges between the WTRU and (e.g., most of) the core network (CN) may not happen in real time. Instead, the satellite may store the messages while in S & F operation. The messages may be forwarded to the CN, for example, once a connection with the MME-NT and MME-T has been re-established. If a response message is needed, the MME-T may locate and forward the response to a second satellite next in line to serve the S & F area. The response may be “stored and forwarded” to the WTRU, for example, once the second satellite reaches the appropriate area.

Store and forward operations may be supported, for example, during procedures that may involve (e.g., require) multiple exchanges between a WTRU and a CN. Examples of such procedures may include the Attach procedure or the tracking area update (TAU) procedure.

Support may include providing coordination of multi-message procedures. Utilizing multiple satellite passes to support multi-message exchange may involve WTRU and CN coordination on which upcoming satellite may deliver the next message.

Support may address latency associated with cyclic prefix (CP) procedures. Utilizing multiple satellite passes to support a multi-message exchange between a WTRU and a CN may introduce substantial latency in procedures (e.g., the Attach procedure may involve four (4) satellite passes to complete).

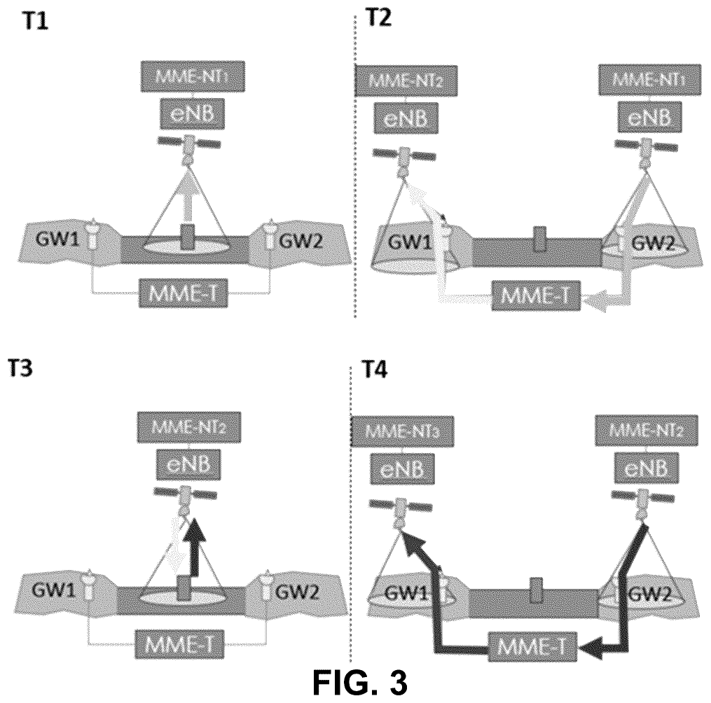

FIG. 3 illustrates an example of multiple exchanges between a WTRU and a CN with multiple satellite passes and extensive delay during store and forward operation, according to an embodiment.

Store and forward operation may utilize (e.g., at least) a full eNB onboard a satellite (e.g., regenerative payload) to continue service with a WTRU, e.g., as opposed to a transparent payload configuration, where an eNB may be located on the ground, such that there may not be service to the WTRU if the satellite does not have a connection to the ground.

Store and forward operation may be supported for multiple satellite passes to complete multi-message transmission exchanges (e.g., during CP procedures like the attach procedure and/or the TAU procedure).

Neighboring cell(s) may be prioritized during an S & F operation, for example, as a function of remaining downlink (DL) NAS messages within an initiated procedure and/or network assistance information. A WTRU (e.g., upon completion of the initiated procedure) may initiate neighbor cell measurements and/or mobility to determine the best available cell to continue a connection.

A WTRU may perform one or more of the following actions/operations. In an example, a WTRU may initiate a cell selection procedure prioritizing cell(s) associated with a satellite that is/are not in store and forward mode. The WTRU may determine a cell is in store and forward mode, for example, based on (e.g., via) assistance information. In an example, the assistance information may be received via a system information block (SIB). The WTRU may prioritize cell(s), for example, by application of a bias (e.g., cell selection bias) and/or adding offset to measurement result value(s). The WTRU may connect to a cell under S & F operation, for example, if no alternative suitable cell is available. The WTRU may transmit a first UL non-access stratum (NAS) message. The WTRU may receive S & F assistance information, which may include, for example, one or more of the following: the neighboring satellite and/or cell(s) where a first (e.g., or subsequent) DL NAS response message may be received; and/or one or more resources (e.g., time period/frequency range, etc.) that a first (e.g., or subsequent) DL NAS response message may be received on. The WTRU (e.g., while waiting for the first (or subsequent) DL NAS response message) may perform, for example, one or more of the following: suspend AS functionality (e.g., neighbor cell measurements, etc.); and/or initiate a random access channel (RACH) to the indicated cell(s) and/or satellite provided within the S & F assistance information. The WTRU (e.g., upon reception of the first (or subsequent) DL NAS response message) may send a second (e.g., or subsequent) UL NAS message. The WTRU (e.g., while the initiated procedure is ongoing) may repeat one or more of the (e.g., preceding) operations, for example, to receive and respond to subsequent DL NAS response messages. The WTRU (e.g., upon reception of the final DL NAS response message) may perform, for example, one or more of the following: initiate cell re-selection; trigger mobility; transmit a measurement report; and/or perform neighbor cell measurements.

The examples described herein may (e.g., equally) apply to procedures involving multiple exchanges between a WTRU and the CN, e.g., including the attach procedure, the tracking area update procedure, and/or RRC Connection release/suspend.

Examples described herein may support and provide service continuity during S & F operation, for example, by ensuring that the WTRU may be connected to an appropriate neighboring satellite to receive subsequent DL response messages during multi-message exchanges between the WTRU and CN. A WTRU may ensure that a connection may be continued on the best cell, for example, by initiating neighbor cell measurements, cell (re)selection, and/or mobility upon completion of the procedure.

One or more of the following may be used to support store and forward (S & F) operation in non-terrestrial networks.

For example, a Split MME may comprise a network architecture in which the MME operation may be split between the satellite and a ground node. An MME-T may be located on the ground, for example, to perform (e.g., all legacy) operations. An “MME-NT” may be located onboard a satellite, for example, to perform a subset of MME functionality onboard.

The terms “S & F mode”, “S & F operation,” and “S & F mode operation” may be used interchangeably to identify a satellite and/or a cell that is operating in store and forward mode. The term network entity may be used identify a cell (e.g., that may be associated with a base station and/or a satellite), a base station, a satellite, etc.

The status unavailable associated with a connection may indicate, for example, that the connection does not exist and/or may not support information transfer.

Assistance information may comprise one or more pieces of information that may be used to support or aid a WTRU and/or a network node to perform an action.

Although examples described herein may refer to a split MME architecture, examples described herein may (e.g., equally) apply to other satellite-based architectures, e.g., including varying levels of core network functionality onboard the satellite.

Although examples described herein may refer to a non-terrestrial network scenario where coverage may be provided via satellites, such examples may (e.g., equally) apply to any scenario where the connection with one or more aspects of a core network may be temporarily unavailable.

Although examples described herein may refer NB-IoT/eMTC device types, such examples may (e.g., equally) apply to other device types (e.g., a WTRU).

Although examples described herein may refer to a particular type of network device (e.g., an eNB), such examples may (e.g., equally) apply to network components/devices of difference generations and/or standards for wireless communications (e.g., gNB).

Examples may refer to a cell under a store and forward operation, which describes a cell being serviced and/or originating from a satellite under a store and forward operation. In an example, a WTRU may detect a cell or cell(s) operating in store and forward mode via an (e.g., explicit) indication (e.g., associated with a physical cell identity (PCI) or within a neighbor cell list, and/or within a configuration associated with the cell).

A WTRU may determine (e.g., implicitly determine) that a cell associated with a cell is under a store and forward operation, for example, based on the cell broadcasting satellite assistance information and/or store and forward assistance information.

A WTRU may provide and/or be provided with assistance information for store and forward operation. For example, a WTRU may provide and/or be provided with information to support WTRU/NW operation (e.g., connection, transmission/reception, data handling, access control, mobility) in a non-terrestrial network that supports store and forward operation. Such information may be referred to as assistance information for store and forward operation.

Store and forward assistance information may be specific to a serving cell and/or a satellite or may (e.g., alternatively) be provided for (e.g., and applicable to) multiple cells/satellites, which may include one or more neighboring cells/satellites. In an example, store and forward assistance information may be common to multiple WTRUs. Such store and forward assistance information may be provided via broadcast signaling, dedicated signaling, or group specific signaling. Store and forward assistance information may be current or may apply at a particular time instance or for a time period (e.g., a time period in the future). In an example, assistance information described herein may be indicated explicitly (e.g., via system information (SI)), for example, provided via one or more configuration(s) (e.g., a “store and forward configuration”). In an example, the assistance information may be obtained, provided and/or interpreted implicitly by a WTRU (e.g., using other information, such as satellite assistance information included within an information element, ntnConfig).

Examples described herein may enable the exchange of (e.g., required/relevant) information between a WTRU and a network to support store and forward operation, which may ensure that information is acquired/available if/when needed and may remain up to date.

Network assistance information may be provided/received for store and forward operation. In some examples, the network may provide assistance information and/or configurations to support WTRU operation in store and forward mode. Examples of network assistance information/configurations may include, for example, one or more of the following: characteristics of store and forward operation; satellite and/or cell information; cell barring and/or access restrictions; data transmissions/reception, data handling and forwarding, and/or inter-satellite routing.

Assistance information may be provided/received. In some examples, the network may provide (e.g., as part of the assistance information for store and forward operation) information regarding the characteristics of a satellite. For example, the network may indicate one or more of the following: whether the satellite is transparent or regenerative; the RAN functionality onboard the satellite (e.g., the network may indicate that it is operating with a full (e) NB onboard, a DU, one or more protocol layers (e.g., PHY+MAC), or no RAN functionality (e.g., in transparent mode)); the CN functionality onboard the satellite (e.g., the network may indicate that a full CN is onboard the satellite, whether the satellite is operating with a split-MME, whether one or more core network functionalities is onboard the satellite (e.g., a home subscriber server (HSS)), or whether no core network functionality is onboard); an indication that storage capacity onboard the satellite is limited; and/or an indication that storage capacity onboard the satellite is full.

In some examples, the network may provide information about the status of the feeder-link connection (e.g., the connection between the satellite and a land-based gateway) for the current satellite/cell. For example, the network may provide one or more of the following: an indication (e.g., a flag or bit) that the feeder-link is unavailable; an indication (e.g., a flag or bit) that the feeder-link is available; the end time of the current feeder-link connection; the duration of the current feeder-link connection (e.g., the duration until the current feeder-link connection becomes unavailable); the start time of a new feeder-link; and/or the duration until a new feeder-link may become available.

In some examples, the network may provide information about the store and forward operation for the current satellite/cell. For example, the network may provide one or more of the following: an indication (e.g., a flag or bit) that the satellite/cell is currently in S & F operation; an indication (e.g., a flag or bit) that the satellite/cell is not currently in S & F operation; the start time of store and forward operation; the end time of store and forward operation; the duration (e.g., a time period) of store and forward operation; and/or the duration (e.g., a time period) until store and forward operation begins.

In some examples, the network may provide information about the store and forward operation for one or more neighboring satellite(s)/cell(s). For example, the network may provide one or more of the following: an indication whether one or more neighbor satellite(s)/cell(s) is in store and forward operation; the start time of store and forward operation for one or more neighbor satellite(s)/cell(s); and/or the end time of store and forward operation for one or more neighbor satellite(s)/cell(s).

Assistance information may be provided/received for satellite/cell access during store and forward operation. In some examples, the network may provide (e.g., as part of the assistance information for store and forward operation) information to support information and/or restrictions to cell access during store and forward operation. For example, the network may indicate that access to a satellite/cell operating in store and forward may be restricted to WTRU(s) that satisfy one or more characteristics, such as, for example, one or more of the following characteristics: able to restrict access to a (e.g., specific) QoS profile; access categories; logical channel; procedure (e.g., TAU procedure, Attach procedure, etc.).

Assistance information may be provided/received for transmission/reception during S & F operation. In some examples, the network may provide (e.g., as part of the assistance information for store and forward operation) information to support transmission and reception while in store and forward operation. For example, the network may indicate one or more of the following: whether a follow up message (e.g., from the core network) may be provided or received; when a follow-up message may be anticipated; and/or information about a subsequent response message.

Assistance information may be provided/received for data handling during S & F operation. In some examples, the network may provide (e.g., as part of the assistance information for store and forward operation) information to support transmission handling while in store and forward operation. For example, the network may indicate one or more of the following: if/when the data may arrive at the CN.

Information routing assistance information may be provided/received. In some examples, the network may not have a direct feeder-link with the ground. The network may still forward information, for example, via inter satellite links (ISL). In some examples, the network may provide (e.g., as part of the assistance information for store and forward operation) information regarding the ability to route information to a ground-based gateway (e.g., or core network), for example, other than by a direct feeder-link connection. For example, the network may indicate one or more of the following: information (e.g., a flag) that the satellite (e.g., without a feeder-link) can use to route information to a gateway.

NW assistance information may be acquired for S & F operation. In some examples, methods to (re) acquire NW assistance information for store and forward operation may be implemented, for example, to ensure that the WTRU may have (e.g., all required) information to continue operation under store and forward mode, and/or to ensure that the information is valid (e.g., up to date).

Triggers may be utilized to acquire/receive store and forward assistance information. In some examples, (re) acquiring assistance information for store and forward operation may be based on satisfaction (e.g., triggering) of one or more criteria. Criteria may be indicated by the network (e.g., via system information or using NAS signaling) and/or may be provided within a configuration. (Re) acquiring store and forward assistance information may be triggered due to a WTRU or network action.

In examples, a WTRU may trigger acquiring store and forward assistance information based on (e.g., upon the occurrence of) satisfaction of one or more of the following criteria and/or performance of one or more of the following actions: upon (re) selecting to an satellite/cell currently operating in S & F mode; upon detecting a satellite/cell may enter S & F operation at a future time; X seconds prior to entering store and forward mode; validity expiry of (e.g., currently stored) store and forward assistance information; and/or upon initiation of a procedure (e.g., a tracking area update procedure, an Attach procedure).

A WTRU may participate in one or more methods of acquiring store and forward Assistance information. A WTRU may obtain S & F operation assistance information, for example, via one or more of the following methods: SIB acquisition; as part of WTRU configuration; and/or based on a NW decision.

In some examples, a WTRU may request assistance information for store and forward operation. The request for assistance information may be via sent, for example, via one or more of the following: uplink control information (UCI), a SR, RACH messaging (e.g., MSGA, MSG3, MSG5, etc.), a PUSCH transmission, a medium access control-control element (MAC CE), and/or RRC signaling. The assistance information request may include a general request (e.g., a flag indicating requesting all available information) and/or may indicate one or more specific requests or information fields for information to be provided to the WTRU.

Store and forward assistance information and/or configuration information may be indicated/configured/provided by signaling. Network assistance information for store and forward operation may be indicated/configured/provided, for example, via one or more of the following signaling methods: a SIB (e.g., within satellite assistance information (e.g., SIB 19, SIB31/32, a new SI block, or within another existing SIB); NAS signaling; a MAC CE; DCI; a RACH message (e.g., MSG2, MSG4, MSGB); RRC (e.g., release message); and/or a PDCCH/PDSCH transmission.

In some examples, a WTRU may receive a dedicated configuration and/or assistance information related to (e.g., for) store and forward operation. A configuration may be used, for example, to provide dedicated information for the WTRU, e.g., as compared to general assistance information that may be broadcast or used by more than one device.

A WTRU (e.g., provided with a dedicated configuration for store and forward operation) may override other assistance information (e.g., received via broadcast signaling) or may combine the (e.g., dedicated) configuration with (e.g., one or more pieces of) assistance information (e.g., to support satellite connection and/or to support store and forward operation). In some examples, the WTRU may use the most recently received information.

A WTRU may maintain a (e.g., dedicated) configuration, for example during one or more of the following: while the WTRU may be connected to the same cell; while the WTRU may be connected to the same satellite; until the WTRU is (e.g., explicitly) released by the NW; and/or upon indication from the network that S & F operation is complete.

A WTRU may determine (e.g., detect) that it no longer needs a (dedicated) configuration, for example. In such a case, the WTRU may release all or part of the configuration, and/or may notify the network that the current configuration is no longer necessary/useful.

Validity of the store and forward assistance information may be determined by a WTRU. Store and forward information may be subject to a validity condition. For example, upon expiry of one or more validity condition(s) associated with the store and forward information, a WTRU may no longer use the store and forward assistance information. A WTRU may consider store and forward assistance information as expired, for example, based on (e.g., upon the occurrence of) one or more of the following: reaching a (e.g., specific) time; expiry of satellite assistance information (e.g., the epoch time of the satellite assistance information); and/or expiry of a timer.

A WTRU, e.g., upon expiry of the store and forward assistance information, may reacquire (e.g., valid) store and forward information (e.g., via one or more methods described herein). A WTRU, e.g., upon expiry of store and forward information, may (e.g., alternatively) reacquire the store and forward assistance information based on one or more criteria. The criteria may include, for example: the serving satellite/cell (e.g., the satellite/cell, the WTRU currently has an active connection with; or the satellite/cell, the WTRU is camped on) is under store and forward operation.

A WTRU may calculate aspects of store and forward assistance information. In some examples, the WTRU may not (e.g., necessarily or always) receive one or more portions/pieces of store and forward assistance information, e.g., in an explicit manner. The WTRU may (e.g., be able to) determine (e.g., implicitly determine) one or more aspects of store and forward operation, for example, based on the use other assistance information.

A WTRU may calculate aspects of store and forward operation characteristics. In some examples, the WTRU may calculate aspects of store and forward operation (e.g., start of store and forward operation) based on the aid of other assistance information provided by the network. For example, a WTRU may use one or more of the following to perform one or more calculations: a reference point; satellite footprint; cell footprint; configuration associated with an NTN (ntnConfig); satellite ephemeris data (e.g., PVT or orbital); and/or T-Service (e.g., start or end of serving cell time).

In an example, a WTRU may calculate the start of store and forward operation by determining that a neighboring cell originating from a satellite under the store and forward operation is about to take over coverage of the current area. The WTRU may determine the t-service of the current cell (e.g., or t-service start of the neighboring cell) to determine when the WTRU may enter S & F operation. In an earth moving cell case, the WTRU may obtain its own position (e.g., via global navigation satellite system (GNSS) and/or other positioning methods) and the reference location and cell diameter of the neighboring cell. The WTRU may calculate the time instance when a WTRU-reference point distance will become less than the cell radius, which may indicate the start of S & F operation for the WTRU.

In some examples, the WTRU may calculate the end of the S & F mode operation, for example, by determining that a neighboring cell originating from a satellite not under store and forward operation is about to take over coverage of the current area form a satellite currently under S & F operation. The WTRU may determine the t-service of the current cell (e.g., or t-service start of the neighboring cell) to determine when the WTRU may exit S & F operation. For an earth moving cell case, the WTRU may obtain its own position (e.g., via GNSS and/or other positioning methods) and the reference location and cell diameter of the neighboring cell. The WTRU may calculate the time instance when the WTRU-reference point distance of the neighbouring cell will be less than the cell radius, which may indicate the end of S & F operation for the WTRU.

In some examples, the WTRU may calculate the duration of S & F mode operation by acquiring its own GNSS location information and satellite assistance information, such as one or more of the following: the satellite footprint coverage information, a satellite reference point, and/or the satellite ephemeris data. The WTRU may determine the time instance when the WTRU will be outside of coverage from the current satellite in S & F operation, for example, via the assistance information (e.g., assuming that the neighboring satellite taking over coverage is not in S & F operation).

A WTRU may provide assistance information for store and forward operation. In some examples, the WTRU may provide assistance information to support NW operation under store and forward mode. WTRU assistance information may include, for example, one or more of the following: capabilities, data characteristic (e.g., QoS profiles), and/or buffered data at the WTRU.

A WTRU may provide WTRU assistance information for S & F operation. In some examples, the WTRU may provide (e.g., as part of the assistance information for store and forward operation) information to support store and forward operation. For example, the WTRU may indicate one or more of the following: capability information for the WTRU to support S & F operation; QoS characteristics of data (e.g., the latency requirements); and/or the buffer status of the WTRU.

Transmission of WTRU assistance information for S & F operation may be triggered by one or more criteria. In some examples, transmission of WTRU assistance information for store and forward operation may be based on satisfaction (e.g., triggering) of one or more criteria. Criteria may be indicated by the network (e.g., within system information or NAS signaling) and/or may be provided within a configuration. (Re) acquiring store and forward assistance information may (e.g., also) be triggered, e.g., due to a WTRU or network action.

In examples, a WTRU may trigger transmission of store and forward assistance information based on (e.g., upon) satisfaction of one or more of the following criteria and/or based on (e.g., upon) performance of one or more of the following actions: connection to the network; during capability signaling exchange; network request (e.g., WTRU information request message) to report the status of the flight path information, e.g., via RRC signaling; and/or when a time interval is reached (e.g., periodically).

WTRU assistance information for S & F operation may be signaled. Network assistance information for store and forward operation may be indicated/configured/provided, for example, via one or more of the following signaling methods: NAS signaling; a RACH message (e.g., MSG1 preamble selection, MSG3, MSGA); a MAC CE; UCI; RRC signaling (e.g., capability signaling, WTRU assistance information); and/or a PUSCH/PUCCH transmission.

Cell (re)selection may be performed during S & F operation. In examples, a WTRU may avoid establishing connection with cell(s) and/or satellite(s) operating in store and forward mode, for example, at least for the reason that additional latency and coordination may be needed to complete a messaging exchange during store and forward operation. A network may indicate to a WTRU that a subsequent message (e.g., a DL NAS response message) is anticipated. The WTRU may prioritize one or more upcoming satellite(s)/cell(s) to receive the subsequent message (e.g., as described herein).

Examples described herein support prioritization of a cell(s)/satellite(s) during store and forward operation, which may reduce (e.g., minimize) connection setup time, for example, if an alternative option to a cell/satellite under store and forward operation is available.

Cell/satellite (re)selection prioritization may be performed during S & F operation. In some examples, a WTRU may prioritize (re)selection to a cell that is not under store and forward operation. The WTRU may (e.g., alternatively) deprioritize a cell that may be operating (e.g., or about to operate) under store and forward mode.

In some examples, a WTRU may receive and/or be configured with one or more cell (re)selection bias(es) to apply to cell ranking measurements, e.g., to prioritize camping on a satellite/cell not under store and forward operation. A bias may be positive or negative. One or more criteria may be associated with a bias. The one or more associated criteria may be applied to a bias, for example, such as one or more of the following: whether a cell is under store and forward operation; NTN deployment scenario (e.g., LEO or GEO); public land mobile network (PLMN) ID; cell ID; frequency or frequency range; and/or a threshold.

Criteria that may be applied to a bias may include whether a cell is under store and forward operation.

Criteria that may be applied to a bias may include an NTN deployment scenario (e.g., LEO or GEO). A WTRU may apply the bias to one or more (e.g., all) cells/frequencies belonging to the deployment scenario (e.g., with satellites operating under store and forward mode).

Criteria that may be applied to a bias may include a PLMN ID (e.g., with satellites operating under store and forward mode). A WTRU may apply the bias to (e.g., all) cells/frequencies associated with the PLMN.

Criteria that may be applied to a bias may include a cell ID (e.g., operating under store and forward mode). A WTRU may apply the bias to the cell.

Criteria that may be applied to a bias may include a frequency or range of frequencies (e.g., operating under store and forward mode). A WTRU will apply the bias to frequencies (e.g., all frequencies) within an indicated range.

Criteria that may be applied to a bias may include a threshold. A WTRU may apply the bias, for example, if the time until a cell enters or exits store and forward operation meets, exceeds, or falls below a configured threshold.

A WTRU may be configured with multiple biases. A WTRU may apply multiple biases (e.g., all biases) for which the associated criteria have been satisfied. In some examples, a WTRU may select the largest absolute value among multiple biases (e.g., all biases). In some examples, the WTRU may select the largest positive and negative bias among multiple biases.

In some examples, a WTRU may (de) prioritize a network type independent of the measurements (e.g., regardless of whether the best frequency/cell is operating under store and forward mode). In an example, the WTRU may evaluate (e.g., only evaluate) candidate cells from a particular network type. In an example, a WTRU may evaluate (e.g., alternatively evaluate) candidate cells from a second network type (e.g., only) after (e.g., all) frequencies/candidate cells have been evaluated from a first network type.

Candidate cells/frequencies may be eliminated based on network type. In some examples, a WTRU may prioritize a cell/satellite under store and forward operation by down-selecting or eliminating candidate cells for cell (re)selection originating from a satellite under store and forward mode operation and/or from a (e.g., particular) network or NTN deployment scenario (e.g., LEO vs. GEO) operating satellites under store and forward mode. The WTRU may eliminate candidate cells and/or frequencies, for example, via one or more of the following methods: barring cells associated with a network type or deployment scenario; barring/not performing measurements on frequencies associated with a network type or deployment scenario with satellites operating under store and forward mode; and/or barring PLMNs associated with a network type or deployment scenario operating under store and forward mode.

A WTRU may prioritize network-types with non-overlapping frequencies. A WTRU may group frequencies associated with store and forward operation, for example, in deployments where satellite(s)/cell(s) operating in store and forward mode are associated with unique frequencies. The WTRU may perform cell ranking based on the associated set of frequencies that are not associated with store and forward operation. If no suitable cells are found, the WTRU may attempt to perform cell ranking on a frequency set belonging to cells that are operating in store and forward mode. For example, during prioritization A, a WTRU may attempt camping on (e.g., all) non-store and forward frequencies. During prioritization B (e.g., following prioritization A), the WTRU may attempt camping on (e.g., all) store and forward frequencies. The procedure may similarly be used to prioritize cell(s)/satellite(s) under store and forward operation (e.g., during reception of subsequent messages).

A WTRU may prioritize network-types with overlapping frequencies. In some deployments, satellites under store and forward operation and not under store and forward operation may have overlapping frequencies. A WTRU may (e.g., always) select a particular satellite type, for example, if a frequency has suitable cells available from both store and forward and non-Store and forward satellites. For example, during prioritization A, the highest priority frequency f1 may have suitable cells that may or may not be operating in store and forward mode. During prioritization A, the WTRU may select (e.g., always select) a cell from a satellite that is not operating in store and forward mode. In prioritization B, the WTRU may select (e.g., always select) a cell from a satellite operating in store and forward mode (e.g., during reception of subsequent messages).

In some scenarios, the highest ranked frequency may include cells that may or may not be operating in store and forward mode, but cell(s) of only one type may be suitable and utilized for prioritization. In example, a WTRU may select a suitable cell, for example, regardless of whether the cell originates from the preferred store and forward operation characteristics. For example, during prioritization A, if the highest priority frequency f1 has only suitable cells operating in store and forward mode, the WTRU may select the store and forward cell.

In some examples, the highest ranked frequency may include cells that may or may not be operating in store and forward mode. In such examples, the suitable cell(s) may be from the non-preferred operating mode. The WTRU (e.g., in pursuit of a preferred operational mode) may move to the next highest-priority frequency until a suitable cell from the preferred operational mode is found. For example, during prioritization A, if the highest priority frequency f1 may have suitable cells operating in store and forward mode, the WTRU may attempt to connect to a cell (e.g., on frequency f2) that is not operating in store and forward mode. If the WTRU does not find any suitable cells on any of frequencies, the WTRU may connect to a suitable store and forward cell on the highest priority frequency. During prioritization B, the WTRU may prefer the cell under store and forward operation (e.g., during reception of subsequent messages).

Examples are provided herein for cell (re)selection (de) prioritization during S & F operation. In some examples, the WTRU may deprioritize one or more cells, for example, by applying a bias to the cell measurements during cell ranking. The WTRU may apply the bias to one or more cells that may be in one or more of the following conditions: each one of the cells are in S & F operation; and/or each one of the cells that are operating in store and forward mode for less than X ms/slots/frames.

In some examples, a WTRU may prioritize one or more cells, for example, by applying a bias to the cell measurements during cell ranking.

In some examples, the duration may be provided for which cell (re)selection prioritization during S & F operation may be applied. In some examples, a WTRU may apply (de) prioritization in discontinuous fashion. For example, the (de) prioritization may be applied for a time period, periodically, or semi-statically (e.g., based on configuration). A WTRU may apply (e.g., alternatively apply) a (de) prioritization upon reception of an indication or satisfaction of one or more criteria, such as, for example, one or more of the following criteria: reception of an NW indication/configuration; detection that a cell and/or satellite may be currently under store and forward operation; and/or detection that a cell and/or satellite may be about to enter store and forward operation.

A WTRU may implement time-based switching between prioritizations. In some examples, the WTRU may apply cell (re)selection (de) prioritization temporarily (e.g., subject to timing conditions). A WTRU may switch between prioritization schemes, for example, based on one or more of the following: while a timer is running; subject to a counter; until an indicated time; and/or for a time period.

A WTRU may perform a prioritization or may switch between prioritization schemes while a timer is running. For example, the WTRU may start a timer upon application of cell (re)selection prioritization. The WTRU may stop cell (re)selection prioritization upon expiry of the timer.

A WTRU may perform a prioritization or may switch between prioritization schemes subject to a counter. For example, the WTRU may apply cell (re)selection prioritization for the next X resources (e.g., frames, subframes, symbols).

A WTRU may perform a prioritization or may switch between prioritization schemes until an indicated time. For example, a WTRU may perform prioritization until 10:00:35 UTC.

A WTRU may perform a prioritization or may switch between prioritization schemes for a time period. For example, a WTRU may perform prioritization between 10:00:35 UTC and 10:00:40 UTC.

In some examples, a WTRU may start a timer, e.g., upon transitioning to RRC IDLE/INACTIVE state (e.g., on reception of an RRCRelease or RRCReleasewithSuspend message). The WTRU may apply cell (re)selection (de) prioritization for (e.g., only for) the indicated or configured duration. In some examples, the WTRU may start a timer or counter upon starting cell (re)selection (de) prioritization. In some examples, the WTRU may start a timer or counter after the last time the WTRU camped on a cell belonging to a network of a particular network type (e.g., a terrestrial cell or a non-terrestrial cell). In some examples, an offset may be applied to the start of the timer.

A WTRU may (e.g., upon expiry of the timing condition(s)) perform, for example, one or more of the following: stop applying cell (re)selection prioritization; revert to a default or alternate cell (re)selection prioritization configuration/method; discard associated cell (re)selection prioritization configuration(s); perform cell (re)selection; perform random access (e.g., transmit a preamble).

A WTRU may perform periodic prioritization. In some examples, a WTRU may apply cell (re)selection (de) prioritization periodically. For example, a WTRU may be provided with a series of times in which to apply cell (re)selection (de) prioritization.

In some examples, a WTRU may be provided/configured with a time (e.g., UTC 10:00:32) and an offset (e.g., 5 minutes or X frames). The WTRU/WTRU-side may apply cell (re)selection (de) prioritization at an (e.g., each) original time+X*Offset, where X may be a configurable number (e.g., an integer).

In some examples, a WTRU may be provided/configured with multiple timers, e.g., a cycle duration and an on-duration. The WTRU may apply cell (re)selection (de) prioritization while the on-duration timer is running. Upon expiry of the on-duration timer, the WTRU may wait until the cycle duration timer restarts before starting the on-duration timer again, when the WTRU may re-apply cell (re)selection prioritization.

A WTRU may perform a cell search while camped on a cell/satellite operating in store and forward mode. In some examples (e.g., if a WTRU is camped (and/or connected) on a cell and/or satellite in store and forward mode), a WTRU may attempt to search for a cell that is not operating in store and forward mode. The WTRU may, for example, increase the frequency of performing a cell search while camped on a cell that is operating in store and forward mode.

In some examples, a WTRU may trigger a cell search based on one or more of the following: satisfaction of a criteria, upon reception of an indication, and/or upon a WTRU/NW action. For example, a WTRU may trigger a cell search based on one or more of the following: the current camped cell entering store and forward operational mode; the current camped cell about to enter (e.g., within a time period) store and forward operational mode; the best ranked cell entering store and forward operational mode; and/or the best ranked cell about to enter (e.g., within a time period) store and forward operational mode.

A WTRU may have connected mobility during store and forward operation. In some examples, a WTRU may have an ongoing RRC connection upon detection that the current cell and/or a neighboring cell may be entering store and forward operational mode. The WTRU may (e.g., in this case) adapt mobility procedures to ensure that the WTRU remains connected to an appropriate cell that can fulfill (e.g., all) QoS requirements.

A WTRU may manage mobility during store and forward mode operation. In some examples (e.g., upon detection that a current cell or candidate cell is under store and forward operation), the WTRU may perform, for example, one or more of the following actions: trigger a measurement report; perform neighbor cell measurements; and/or apply an alternative measurement configuration.

A WTRU may manage (pre) configured mobility during store and forward mode operation. A WTRU may be configured to apply mobility handling (e.g., a specific mobility handling) to (pre) configured mobility candidates, for example, based on the whether a neighboring candidate cell is under or about to enter store and forward operation. A configuration for (pre) configured mobility handling may include, for example, one or more of the following: a flag to enable/disable modified handling of (pre) configured mobility candidates based on store and forward operational mode; one or more bias(es) to apply (e.g., to the triggering event) in case a candidate cell may enter store and forward operational mode; a configuration to release the candidate in case the candidate cell may be impacted by store and forward operation; and/or a configuration to report to the network in case a candidate cell may be impacted by store and forward operation.

Upon detection that a preconfigured mobility candidate (e.g., conditional handover (CHO) or L1/L2 triggered mobility (LTM) candidate) may be (e.g., will be) affected by store and forward operation at some point in the future, the WTRU may apply one or more of the following actions to the (pre) configured mobility configuration: WTRU may release the candidate configuration; WTRU may suspend CHO or LTM candidates; WTRU may bias triggering conditions for CHO or LTM execution; and/or WTRU may trigger CHO or LTM, but may not apply the RRC reconfiguration message/synchronize with the upcoming cell, for example, until the store and forward operation is over.

A WTRU may trigger (pre) configured mobility, for example, if the serving cell is impacted by store and forward operation or (e.g., alternatively) if the radio conditions otherwise degrade, e.g., due to fading. For example, the WTRU may be provided with multiple thresholds. If the first threshold is satisfied, the WTRU may suspend the configuration. If the second threshold is satisfied, the WTRU may trigger mobility.

In some examples (e.g., if a candidate configuration may be impacted by a future store and forward operation), the WTRU may perform one or more actions (e.g., bias triggering conditions, suspending a candidate, etc.) indefinitely or (e.g., only) for the duration of the store and forward operation.

A WTRU may report candidate handling to a network. A WTRU may report to the network, for example, if the WTRU applied a (pre) configured bias, or suspended a (pre) configured mobility candidate. A WTRU may determine (e.g., based on a configuration) whether to report the impact to a (pre) configured mobility candidate to the network. For example, the WTRU may report that it applied a modified handling of a configured mobility candidate based on one or more of the following conditions: the WTRU released a (pre) configured mobility candidate; the WTRU applied a bias to a (pre) configured mobility candidate; the WTRU suspended a (pre) configured mobility candidate; and/or if the duration of the modified handling of (pre) configured candidates exceeds a threshold.

Messaging may occur during S & F operation. Multiple satellite passes may be involved to complete one or more procedures (e.g., a TAU procedure, an Attach procedure). Coordination may be used to enable the WTRU to connect to the appropriate satellite at the appropriate time to receive a NW response. Handling of the initial transmission in a procedure may differ from how the WTRU may handle a subsequent transmission, for example, since the subsequent transmission may be available (e.g., only) on specific satellites where the message may have been stored.

Examples described herein may support messaging during store and forward operation. The messaging may enable selection of a cell (e.g., an appropriate cell) for initial transmission, and/or prepare the WTRU for reception of subsequent signaling.

A WTRU and satellite may engage in an initial transmission/reception during S & F operation. Initial transmission to a satellite under store and forward operation may allow additional choice, for example, considering the WTRU may select a (e.g., any) suitable satellite to initiate the procedure (e.g., unlike reception of a subsequent response message that may be restricted to a particular cell, satellite, or set of cells).

Additional considerations may be considered during initial transmission/reception during store and forward operation, for example, considering the additional latency to initiate a procedure on a satellite under store and forward operation and implementation restrictions onboard the satellite (e.g., storage limitations).

Access restrictions may be imposed during store and forward operation. In some examples, access to a cell (e.g., camping, random access) may be restricted during store and forward operation. A WTRU may attempt a connection, for example, if the WTRU satisfies restrictions. The WTRU may be barred or may not attempt access to the cell, for example, if one or more of the restrictions apply to the WTRU.

During store and forward operation, a WTRU may be restricted based on one or more of the following: access restriction to a (e.g., specific) QoS profile; device type; access categories; logical channel; procedure (e.g., a TAU procedure, an Attach procedure, etc.); and/or whether there is sufficient remaining storage onboard the satellite.

While restricted, the WTRU may perform, (e.g., only perform) one or more of the following actions: RACH; allow access (e.g., only allow access) based on specific access categories (e.g., for emergency calls); and/or allow access (e.g., only allow access) if the WTRU has already connected to the core network.

Access restriction(s) may apply indefinitely, or conditionally based on, for example, one or more of the following: while the satellite is under store and forward operation; and/or a time period.

A WTRU connection may be rejected during store and forward operation. A WTRU may be rejected during store and forward operation, for example, due to storage limitations on the satellite. Upon connection setup (e.g., during random access or RRC connection establishment), the WTRU may receive a rejection from the network, for example, due to store and forward operation.

Upon rejection due to store and forward, a WTRU may be provided with additional information (e.g., to determine the cause of rejection and/or to support a subsequent attempt at connection). The information may include, for example, one or more of the following: the cause for the rejection (e.g., due to S & F operation, a full satellite storage); and/or a time to reattempt connection (e.g., when store and forward operation is complete).

Upon rejection from an attempted connection, the WTRU may perform one or more of the following actions: bar the cell; bar cell(s) originating from the same satellite the rejection was received from; perform cell reselection; and/or apply a prioritization action (as described herein).

The WTRU may perform limited reception during store and forward operation. During store and forward operation, the WTRU may not have as many opportunities to receive DL signaling (e.g., greater gap between reception opportunities) due to having to wait for a second satellite to provide a response message or subsequent message. The WTRU may limit or reduce the occasions the WTRU spends monitoring for DL paging when connected to a satellite in store and forward operation.

In some examples, the WTRU may apply a different paging configuration during S & F operation.

WTRU application of differentiated monitoring (e.g., for reception) may depend on, for example, one or more of the following: NW indication; and/or satellite operating in store and forward mode.

A WTRU may perform subsequent transmission/reception during S & F operation. Some procedures in store and forward operation may involve interaction with the core network (e.g., during a TAU procedure, an Attach procedure), which may be ongoing. The WTRU may be restricted to receiving subsequent response messages from a specific cell, a set of cells, or a satellite (e.g., based on which satellite the response message is stored on).

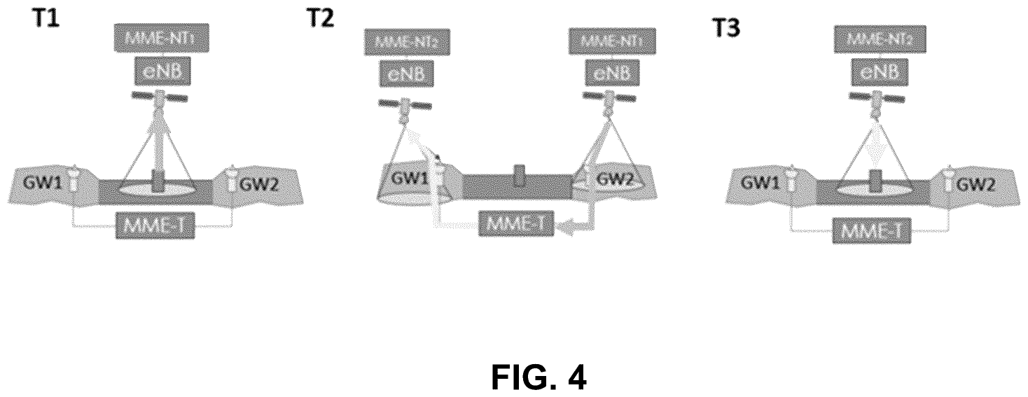

FIG. 4 illustrates an example of reception of a subsequent DL response message from the CN during S & F operation according to an embodiment. As illustrated in FIG. 4, the WTRU that transmits a first UL message to satellite 1 at T1 may wait until T3 for reception of the subsequent DL response from a second satellite.

WTRU behavior may be limited while awaiting a subsequent message during store and forward operation. One or more procedures in store and forward operation may involve interaction with the core network (e.g., a TAU procedure, an Attach procedure), which may be ongoing. The WTRU may be limited in operation (e.g., what the WTRU may do) while the WTRU is waiting for a subsequent satellite that may store a response message. The WTRU may perform, for example, one or more of the following actions (e.g., while awaiting the next satellite that can provide a subsequent DL response to become available): suspend AS functionality (e.g., neighbor cell measurements, etc.); and/or initiate RACH to the indicated cell(s) and/or satellite that may be provided in the S & F assistance information.

A WTRU may prioritize a (e.g., specific) cell/satellite during store and forward operation (e.g., using one or more of the mechanisms described herein). The WTRU may provide additional assistance information to the network regarding, for example, how follow up messages may be received. Additional assistance information may include, for example, one or more of the following: preferred neighbor cell the WTRU may monitor to receive the follow up message; and/or time duration the WTRU may monitor for the follow up message (e.g., may be provided by the WTRU or the network).

A WTRU may receive a subsequent message during store and forward operation. A WTRU may detect the satellite and/or cell that has a subsequent DL message for the WTRU (e.g., via the store and forward satellite assistance information). The WTRU may (e.g., based on the detection) perform, for example, one or more of the following: cell measurement(s); reselection to the cell; and/or RACH.

A WTRU may have prioritized access to a cell/satellite from which the WTRU may be expecting to receive a subsequent message. For example, the WTRU may perform one or more of the following (e.g., for satellite(s)/cell(s) the WTRU may be expecting a DL response from): access the cell with a (e.g., specific) resume cause/access class; access the cell with (e.g., specific) resources/RNTIs/RAC occasions, etc.; and/or provide an indication that the WTRU may be awaiting a message (e.g., special SR).

A WTRU may provide a response message (e.g., if required to continue/complete a procedure). The WTRU may (e.g., if a further response is required from the network) re-apply a similar procedure to receive a subsequent DL response message.

A WTRU may fail to receive subsequent message during store and forward operation. In some scenarios, the WTRU may not be able to receive a subsequent message in a procedure during store and forward operation. A failure may occur, for example, due to missing store and forward assistance information, poor connection quality, and/or the WTRU moving outside of the coverage area of the subsequent store and forward satellite.

A WTRU may (e.g., if the WTRU is not able to receive a subsequent DL message on the expected cell), for example, perform one or more of the following: terminate procedure and trigger a (e.g., any) cell search; access a follow-up cell (e.g., continue procedure subject to a timer, if timer expires, then restart procedure); provide indication of failure to network; and/or start a timer.

Whether the WTRU declares a failure and/or the actions the WTRU performs may be subject to a timer. In some examples, the WTRU may start a timer if/when the procedure is initiated. The WTRU may continue to attempt to receive a DL response message (e.g., while the timer is ongoing). the WTRU may abort the current procedure, for example, upon timer expiry.

A WTRU may cancel an ongoing procedure during store and forward operation. In some examples, while the WTRU has an ongoing procedure initiated on a satellite in store and forward operation, the WTRU may detect a suitable cell and/or satellite that may not currently be in store and forward operation. The WTRU may determine whether to continue the procedure under store and forward operation or terminate the procedure and re-initiate on the satellite under normal (e.g., non-store and forward) operation.

A WTRU may determine whether to terminate a procedure, for example, depending on one or more factors/criteria. For example, a WTRU may determine whether to terminate a procedure based on one or more of the following: if the satellite in normal operation may enter store and forward operating mode soon (e.g., within a time period); and/or when the current procedure may be expected to be completed.

The WTRU may (e.g., based on the termination determination) perform one or more of the following actions: detect another cell (e.g., not in S & F operation) during an ongoing S & F messaging exchange; continue message exchange; and/or reselect to another cell not in S & F operation.

A WTRU may perform connection handling during store and forward operation. During store and forward operation, the WTRU may modify or adapt how it handles an ongoing connection while connected to a satellite operating in store and forward mode.

WTRU behavior may be based on completion of a procedure in store and forward operation. The WTRU may adapt how it handles other satellites in store and forward mode, for example, upon completion of (e.g., certain) procedures in store and forward operation that may involve interaction with the core network (e.g., a TAU procedure, an Attach procedure). For example, the WTRU may continue information exchange as normal, e.g., since the termination point for AS/NAS signaling is onboard a satellite.

For example, upon completion of procedures affected by store and forward operation (e.g., a TAU procedure, an Attach procedure), the WTRU may perform one or more of the following actions: suspend cell/satellite (de) prioritization; and/or perform cell reselection.

A WTRU may manage an RRC state during store and forward operation. In some examples, while awaiting subsequent DL signaling in certain procedures, a WTRU may not maintain (e.g., always maintain) a connection to the RAN. The WTRU may maintain connection with the CN while the procedure is ongoing. WTRU operation may be similar to RRC INACTIVE state, although some limited capability device types (e.g., NB-IoT) may not support RRC INACTIVE state.

Latency may be adapted during S & F operation. Considering the additional latency to NAS procedures introduced by store and forward operation, NAS timer(s) may be adapted to avoid premature expiry while awaiting a DL response message from a subsequent satellite.

Adaptation of NAS timer(s) during store and forward operation may avoid premature expiry (e.g., and associated actions) while not preventing recovery actions if expired due to other reasons.

In some examples, a WTRU may adapt existing NAS timers, e.g., to account for additional latency that may be introduced by a store and forward procedure. For example, a WTRU may adapt one or more of the following NAS timers: T3402, T3410, T3411, T3416, T3417 (ext), T3418, T3420, T3421, T3423, T3430, T3440, T3442.

A WTRU may perform, for example, one or more of the following actions to a timer: suspend a timer; stop a timer; (re) start a timer; apply an offset to the start of a timer; extend the duration of a timer; and/or apply a different default value.

A WTRU may select how to handle (e.g., adapt) a timer, for example, based on the current status of the timer. For example, the WTRU may offset the start of the timer if the timer is not currently running. In some examples, the WTRU may suspend or extend a timer duration if the timer is currently running.

In some examples, the WTRU may introduce and/or use an (e.g., a new) NAS timer for store and forward operation.

A timing offset may be selected, determined (e.g., calculated), indicated, etc. In some examples, the network may provide an offset (e.g., a dedicated offset) to be applied to NAS timer(s). The offset may be provided as part of store and forward assistance information. The offset may be a common offset to apply to (e.g., all) timers, to specific timers, or each timer may be associated with a different offset value.

In some examples, a WTRU may adapt a time (e.g., each timer) autonomously (e.g., based on WTRU calculation). The adaptation may be based on, for example: dynamic adaptation based on type of message exchange (e.g., how many message interactions are needed); using the satellite assistance information of one or more upcoming satellites to predict how long the messaging exchange will take and offset the timers.

A WTRU may apply an adaptation, for example, upon activation of store and forward operation. Whether the WTRU is able to autonomously adjust timers may be based on, for example, being enabled by the network. The WTRU may (e.g., also) notify the network that it has adjusted one or more timers. The WTRU may provide the value(s) used to adjust the timers.

Examples described herein may be utilized to support S & F operation. Messaging continuity during S & F operation may be provided. Systems and methods may be provided for prioritizing neighboring cell(s) during S & F operation. For example, prioritizing neighboring cell(s) during S & F operation may be provided as a function of remaining DL NAS messages within an initiated procedure and/or network assistance information. The WTRU (e.g., upon completion of the initiated procedure) may initiate neighbor cell measurements and/or mobility to determine the best available cell to continue connection.

A WTRU may perform one or more of the following actions/operations. For example, the WTRU may initiate a cell selection procedure prioritizing cell(s) from a satellite that are not in store and forward operation. The WTRU may obtain assistance information (e.g., receive assistance information from a cell via SIB). Based on the assistance information, the WTRU may determine that the cell is in store and forward mode. The WTRU may prioritize cell(s), for example, based on application of a bias and/or offset to measurements. The WTRU may (e.g., if an alternative suitable cell is not available) connect to the cell that is operating in store and forward mode. The WTRU may transmit a first UL non-access stratum (NAS) message (e.g., Registration Request to initiate an ATTACH procedure).

The WTRU may receive store and forward assistance information, which may include, for example, one or more of the following: the neighboring satellite and/or cell(s) where a first DL NAS response message can be received; and/or one or more resources (e.g., time period/frequency range, etc.) that a first DL NAS response message can be received on.

The WTRU (e.g., while waiting for the first DL NAS response message) may perform, for example, one or more of the following: suspend access stratum (AS) functionality (e.g., neighbor cell measurements, etc.); and/or initiate RACH to the indicated cell(s) and/or satellite provided within the S & F assistance information.

The WTRU (e.g., upon reception of the first DL NAS response message) may send a second UL NAS message (e.g., Authentication Response to continue the Attach procedure). The WTRU (e.g., while the initiated procedure is ongoing) may repeat one or more actions/operations to receive and respond to subsequent DL NAS response messages (e.g., the Security mode command message). The WTRU (e.g., upon reception of the final DL NAS response message, such as upon reception of Attach Accept), may, for example, perform one or more of the following: initiate cell re-selection; trigger mobility; transmit a measurement report; and/or perform neighbor cell measurements.

While examples refer to messages from the Attach procedure as an example, examples may (e.g., equally) apply to other procedures involving WTRU-CN messaging, such as the tracking area update (TAU) procedure and/or RRC Connection release/suspend.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

Systems, methods, and instrumentalities are described herein related to support for store and forward operations, e.g., in non-terrestrial networks (NTNs). An example device may include a processor configured to perform one or more actions (e.g., to accomplish a method/procedure). For example, a device (e.g., a wireless transmit/receive unit (WTRU)) may (e.g., be configured to) prioritize a network entity (e.g., a neighboring cell, a base station, a satellite, etc.) during store and forward operation. The network entity may be part of an NTN. The device may obtain store and forward assistance information by receiving it from a network or deriving it based on other assistance information. The store and forward assistance information may include an identification of the network entity where the DL CN message is available, and an indication of a set of resources (e.g., time/frequency resources) on which the DL CN message is available for reception, wherein the processor is configured to receive the DL CN message on the set of resources.

The device may prioritize a network entity during store and forward operation based on at least remaining downlink (DL) non-access stratum (NAS) messages associated with an initiated procedure (e.g., a TAU procedure or an attach procedure) and/or the obtained network assistance information. Prioritizing a network entity may include determining whether the network entity is in store and forward mode. If no alternative suitable cell is available, the device may connect with the network entity that may be operating in store and forward mode. The device as part of the prioritization may apply a cell selection bias and/or offset to measurements. The device may send messages (e.g., RACH messages) to initiate a connection (e.g., a random access procedure) with the prioritized network entity.

The device, while waiting for a DL NAS message (e.g., a subsequent DL NAS response message), may suspend an AS functionality or initiate a random access (or RACH) procedure with the network entity.

The device (e.g., upon completion of the initiated procedure, for example, by receiving the final DL NAS messages associated with the initiated procedure) may perform one or more of the following: initiate neighbor cell measurements and/or mobility to determine the best available cell to continue connection.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-20. (canceled)

21. A wireless transmit/receive unit (WTRU) comprising:
a processor configured to:
identify a first cell associated with a first network entity and a second cell associated with a second network entity;
obtain assistance information associated with the first network entity or the second network entity, wherein the assistance information indicates a condition;
determine that the condition is satisfied;
based at least on the determination that the condition is satisfied, prioritize the second cell associated with the second network entity over the first cell associated with the first network entity; and
perform cell reselection with the second cell associated with the second network entity.

22. The WTRU of claim 21, wherein the condition is determined to be satisfied based on a determination that a network type associated with the first cell is barred.

23. The WTRU of claim 22, wherein the network type is a terrestrial or non-terrestrial cell.

24. The WTRU of claim 21, wherein the condition is determined to be satisfied based on a determination that the first network entity operates via a store and forward mode.

25. The WTRU of claim 21, wherein the condition is determined to be satisfied based on a determination that a bias associated with the first cell or the second cell satisfies a threshold.

26. The WTRU of claim 21, wherein the condition is determined to be satisfied based on a determination that a frequency assigned to the first cell is associated with a store and forward mode.

27. The WTRU of claim 21, wherein the prioritization of the second cell associated with the second network entity is further based on a time period, wherein the assistance information indicates the time period.

28. The WTRU of claim 21, wherein the processor is further configured to:
deprioritize the second cell associated with the second network entity based on an expiration of a timer, wherein an indication of a value of the timer is obtained via the assistance information.

29. A method comprising:
identifying a first cell associated with a first network entity and a second cell associated with a second network entity;
obtaining assistance information associated with the first network entity or the second network entity, wherein the assistance information indicates a condition;
determining that the condition is satisfied;
based at least on the determination that the condition is satisfied, prioritizing the second cell associated with the second network entity over the first cell associated with the first network entity; and
performing cell reselection with the second cell associated with the second network entity.

30. The method of claim 29, wherein the condition is determined to be satisfied based on a determination that a network type associated with the first cell is barred.

31. The method of claim 30, wherein the network type is a terrestrial or non-terrestrial cell.

32. The method of claim 29, wherein the condition is determined to be satisfied based on a determination that the first network entity operates via a store and forward mode.

33. The method of claim 29, wherein the condition is determined to be satisfied based on a determination that a bias associated with the first cell or the second cell satisfies a threshold.

34. The method of claim 29, wherein the condition is determined to be satisfied based on a determination that a frequency assigned to the first cell is associated with a store and forward mode.

35. The method of claim 29, wherein the prioritization of the second cell associated with the second network entity is further based on a time period, wherein the assistance information indicates the time period.
